(19) United States
(12) Patent Application Publication
(10) Pub. No.: US 2017/0367133 A1
(43) Pub. Date: Dec. 21, 2017

(54) COMMUNICATION DEVICE PERFORMING DEVICE-TO-DEVICE COMMUNICATION AND OPERATING METHOD THEREOF

(71) Applicant: Samsung Electronics Co., Ltd., Suwon-si (KR)

(72) Inventors: Kwon-yeol PARK, Jeonju-si (KR); Chan-young KIM, Bucheon-si (KR); Sang-hyun LEE, Seongnam-si (KR)

(73) Assignee: Samsung Electronics Co., Ltd., Suwon-si (KR)

(21) Appl. No.: 15/401,688

(22) Filed: Jan. 9, 2017

(30) Foreign Application Priority Data
Jun. 17, 2016 (KR) 10-2016-0075829

(51) Int. Cl. H04W 76/02; H04W 72/04

(52) U.S. Cl. CPC H04W 76/023; H04W 72/04

(57) ABSTRACT

A communication device performing device-to-device (D2D) communication and an operating method of the communication device are provided. The operating method of the communication device includes receiving a first message, the first message including resources of a direct link for device-to-device (D2D) communication from a base station, receiving a second message, the second message including first information from a counterpart terminal of the D2D communication, the first information related to channel information of a downlink of cellular communication and channel information of the direct link, and selecting one of the cellular communication or the D2D communication as a communication mode with the counterpart terminal, based on channel information of an uplink of the cellular communication and the received first information.

### CROSS-REFERENCE TO RELATED APPLICATION

This application claims priority under 35 U.S.C. §119 to Korean Patent Application No. 10-2016-0075829, filed on Jun. 17, 2016, in the Korean Intellectual Property Office, the disclosure of which is incorporated herein in its entirety by reference.

### BACKGROUND

The inventive concepts relate to communication devices, and more particularly, to communication devices performing device-to-device (D2D) communication and/or operating methods thereof.

Recently, as a large amount of data is transmitted and received by using a mobile device (e.g., a smartphone), an overload in a mobile communication network frequently occurs, and thus network errors tend to increase. As a method for reducing the overloads in the mobile communication network, a technology of device-to-device communication (hereinafter, referred to as D2D communication) between user equipment (UE) has been proposed. According to the D2D communication, terminals may directly transmit and receive data via a direct link (e.g., a side link) between the terminals, without relaying the data through a base station (e.g., evolved Node B (eNB)).

The base station may determine whether to permit the D2D communication between the terminals. For example, the base station may determine whether to permit the D2D communication between the terminals with reference to channel information of an uplink, channel information of a downlink, and channel information of a direct link in cellular communication in which communication is relayed through the base station. However, in order for the base station to obtain the channel information of the uplink, the downlink, and the direct link, a significant amount of signaling is needed between the base station and the terminals. Accordingly, system performance may be degraded due to such signaling overheads.

### SUMMARY

The inventive concepts provide communication devices capable of improving system performance by reducing an amount of signaling needed to select a communication mode (e.g., cellular communication or device-to-device (D2D) communication), and/or operating methods of the communication devices.

According to an aspect of the inventive concepts, an operating method of a communication device may include receiving a first message, the first message including resources of a direct link for device-to-device (D2D) communication from a base station, receiving a second message, the second message including first information from a counterpart terminal of the D2D communication, the first information related to channel information of a downlink of cellular communication and channel information of the direct link, and selecting one of the cellular communication or the D2D communication as a communication mode with the counterpart terminal, based on channel information of an uplink of the cellular communication and the received first information.

According to another aspect of the inventive concepts, a communication device performing device-to-device (D2D) communication may include a memory configured to store programs related to selecting a communication mode, and a processor connected to the memory and configured to execute the programs to perform a comparison operation using first information provided from an counterpart terminal of the D2D communication and second information stored in the communication device and select one of cellular communication and the D2D communication as a communication mode with the counterpart terminal based on a result of the comparison operation.

According to an aspect of the inventive concepts, an operating method of a communication device may include preforming signaling at least one of periodically or non-periodically between at least one base station and a plurality of devices including the communication device, receiving a first message, the first message including resources of a direct link for device-to-device (D2D) communication from the base station, transmitting a channel information calculation message to at least one counterpart device from among the plurality of devices, receiving a second message from the counterpart device, the second message including first information from the counterpart device of the D2D communication, the first information being a value calculated using channel information of a downlink of cellular communication and channel information of the direct link, and selecting one of the cellular communication or the D2D communication as a communication mode with the counterpart device, based on channel information of an uplink of the cellular communication and the received first information.

### BRIEF DESCRIPTION OF THE DRAWINGS

Example embodiments of the inventive concepts will be more clearly understood from the following detailed description taken in conjunction with the accompanying drawings in which:

FIG. 1 is a view showing an operation concept of a cellular communication system according to an example embodiment;

FIG. 2 is a block diagram of a mode selection circuit of FIG. 1, according to an example embodiment;

FIGS. 3 and 4 are views of signaling and a structure of a messages for selecting a communication mode, according to some example embodiment;

FIGS. 5A and 5B are block diagrams illustrating processes of selecting a communication mode between the terminals, according to some example embodiments;

FIGS. 6A, 6B, 6C, and 6D are formulas representing examples of various calculations and comparisons related to selecting a communication mode;

FIGS. 7 and 8 are flowcharts illustrating operating methods of a communication terminal, according to some example embodiments;

FIGS. 9A, 9B, and 9C are tables showing examples of selecting a communication mode according to qualities of forward and reverse channels of a direct link;

FIG. 10 is a view of an example of signaling for determining whether to maintain a selected link;

FIGS. 11 and 12 are views of a message and a structure of the message transmitted between a base station and terminals for determining whether to maintain a link illustrated in FIG. 10;

FIG. 13 is a view of an example of an operation of a communication system, the operation including selecting a communication mode by using only information of a forward channel of D2D communication;

FIG. 14 is a block diagram of a modem chip configured to perform communication mode selection according to an example embodiment;

FIGS. 15A, 15B, and 15C are block diagrams of various examples of determining whether to attempt D2D communication;

FIG. 16 is a block diagram of an example in which one transmitting terminal performs one-to-many D2D communication with at least two receiving terminals; and

FIG. 17 is a block diagram of an example in which a communication method according to an example embodiment is applied to an internet of things.

### DETAILED DESCRIPTION

Hereinafter, some example embodiments of the present inventive concepts will be described in detail with reference to the accompanying drawings.

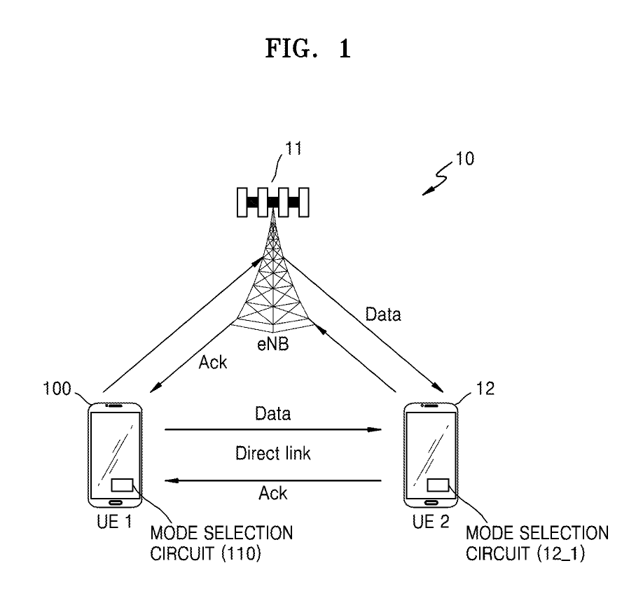

FIG. 1 is a view showing an operation concept of a cellular communication system 10 according to an example embodiment.

Referring to FIG. 1, the communication system 10 may include a base station eNB and 11, and a plurality of communication devices in a cell coverage of the base station 11. The communication device may refer to a transmitting terminal configured to transmit information and a receiving terminal configured to receive information. Also, the communication device may correspond to a transceiver performing both transmitting and receiving functions. Hereinafter, the communication device will be referred to as a terminal.

The base station 11 may correspond to Node B, eNode B (eNB), access point (AP), etc. and may be a node for communication with a terminal. Each of terminals 100 and 12 may be as a mobile or a stationary user terminal (e.g., user equipment (UE), a mobile station (MS), or an advanced mobile station (AMS).

The plurality of terminals 100 and 12 may operate in a cellular communication mode (or a relay communication mode) in which communication is relayed through the base station 11, or in a mode of direct communication between terminals (for example, a device-to-device (D2D) communication mode). For example, a first terminal UE 1, 100 and a second terminal UE 2, 12, which are illustrated in FIG. 1, may transmit and receive data via the cellular communication mode or the D2D communication mode. When the first terminal 100 transmits data to the second terminal 12 via the D2D communication, the first terminal 100 corresponds to a transmitting terminal, and the second terminal 12, which is a counterpart terminal of the D2D communication, corresponds to a receiving terminal.

When the first terminal 100 transmits data to the second terminal 12 in the cellular communication mode, the first terminal 100 may transmit data Data to the base station 11 via an uplink with the base station 11, and the base station 11 may transmit the data Data to the second terminal 12 via a downlink with the second terminal 12. Also, when the second terminal 12 has normally received the data Data, the second terminal 12 may transmit an acknowledgement signal Ack to the base station 11 via an uplink and the base station 11 may transmit the acknowledgment signal Ack to the first terminal 100 via a downlink.

In the D2D communication mode, the first terminal 100 and the second terminal 12 may communicate with each other via a direct link between the first and second terminals 100 and 12, as illustrated in FIG. 1. The direct link may be referred to as a side link because the direct link does not pass through the base station 11. Although FIG. 1 shows an example of performing the D2D communication between the first and second terminals 100 and 12 located in the cell coverage of the same base station 11, example embodiments of the present inventive concepts are not limited thereto. The D2D communication may be performed between terminals linked to different base stations.

For example, for bidirectional communication, resources of the direct link may include a forward channel transmitting a signal (for example, data Data) from the first terminal 100 to the second terminal 12, and a reverse channel transmitting a signal (for example, an acknowledgement signal Ack) from the second terminal 12 to the first terminal 100. The resources of the direct link may be assigned by the base station 11. For example, the base station 11 may assign some of its resources (e.g., a resource of the uplink) used in the cellular communication as the resources of the direct link.

Communication methods supporting both the cellular communication mode and the D2D communication mode may include, for example, third generation partnership project (3GPP), long term evolution (LTE), and long term evolution-advanced (LTE-A) systems. However, example embodiments of the present inventive concepts are not limited thereto, and may be applied to various types of communication systems. If the D2D communication mode is supported, traffic concentrated to the base station 11 may be distributed.

According to an example embodiment, the cellular communication mode or the D2D communication mode may be selected as in the communication system 10, the first and second terminals 100 and 12 may obtain various channel information for selecting the communication mode, and the first and second terminals 100 and 12 may operate according to the selected communication mode. For example, when the first terminal 100 transmits data to the second terminal 12, in the cellular communication mode, the data Data may be transmitted via the uplink between the first terminal 100 and the base station 11 and the downlink between the base station 11 and the second terminal 12. In the D2D communication mode, the data Data may be transmitted via the direct link between the first terminal 100 and the second terminal 12. To select a communication mode, signaling may be performed between the first terminal 100 and the second terminal 12, and the first terminal 100 may select the cellular communication mode or the D2D communication mode according to channel information of the uplink, channel information of the downlink, and channel information of the direct link.

The channel information of the uplink, the downlink, and the direct link may be defined as various values. According to an example embodiment, the channel information may correspond to a value obtained by calculating channel quality of each of the uplink, the downlink, and the direct link. For example, the channel information may correspond to a value corresponding to a distance reflecting a path-loss of each of the uplink, the downlink, and the direct link. In some example embodiments, the channel information may have a value corresponding to a signal-to-noise ratio (SNR), a signal-to-interference and noise power ratio (SINR), or received signal strength (RSS) of each of the uplink, the downlink, and the direct link. In addition, the channel information may be defined as various types of values which may reflect channel quality (e.g., a channel capacity). In the example embodiments hereinafter, selecting a communication mode by using channel information may denote selecting a communication mode by using values of channel quality of various links described above.

According to an example embodiment, in order to select a terminal-based communication mode, the first terminal 100 may include a mode selection circuit 110. Also, the second terminal 12 may include a mode selection circuit 12_1. The first terminal 100 may perform various signaling with the base station 11 and the second terminal 12 under control of the mode selection circuit 110, and select a communication mode.

As an example of the signaling, the first terminal 100 may transmit to the base station 11 a D2D request message for D2D communication with the second terminal 12. The base station 11 may transmit a D2D response message, which indicates resources (e.g., a channel of the direct link) assigned for the D2D communication, to the first terminal 100 and the second terminal 12 in response to the D2D request message.

Due to the signaling between the first terminal 100 and the second terminal 12, the channel information (or a value obtained by calculating channel quality) of the direct link may be calculated. For example, each of the first terminal 100 and the second terminal 12 may identify a code value of a preamble included in the D2D response message provided from the base station 11. The first terminal 100 may transmit a channel information calculation message including the preamble to the second terminal 12 via the channel of the direct link. The second terminal 12 may calculate the channel information of the direct link via the received preamble.

The second terminal 12 may transmit a channel response message including information, through which the calculated channel information of the direct link to the first terminal 100 can be determined (or predicted), in response to the channel information calculation message from the first terminal 100.

The base station 11, the first terminal 100, and the second terminal 12 may periodically or non-periodically perform signaling in a state in which the base station 11, the first terminal 100, and the second terminal 12 are linked to one another, and transmit and receive various channel information and calculate various channel information. For example, the first terminal 100 may transmit channel information of a downlink between the first terminal 100 and the base station 11 to the base station 11. The first terminal 100 may transmit a preamble (or data) for calculating channel information of an uplink to the base station 11. The base station 11 may calculate the channel information of the uplink between the base station 11 and the first terminal 100 via the received preamble. The base station 11 may transmit the channel information of the uplink to the first terminal 100.

Similarly, the second terminal 12 may transmit channel information of a downlink between the second terminal 12 and the base station 11 to the base station 11. The second terminal 12 may transmit a preamble (or data) for calculating channel information of an uplink to the base station 11. The base station 11 may calculate the channel information of the uplink between the base station 11 and the second terminal 12 via the received preamble. The base station 11 may transmit the channel information of the uplink to the second terminal 12.

The first and second terminals 100 and 12 may perform various calculations and comparisons for a terminal-based communication mode selection, and the first terminal 100 may select a communication mode according to the results of the calculations and comparisons. The calculations and comparisons for selecting a communication mode may be performed by various methods. For example, part of the calculations and comparisons may be performed by the first terminal 100, and the rest may be performed by the second terminal 12. For example, the second terminal 12 may perform calculation using the channel information of the downlink and the channel information of the direct link, and transmit a result of the calculation to the first terminal 100 via the channel response message described above. The first terminal 100 may perform comparison with respect to the channel information of the uplink and the result of the calculation from the second terminal 12 to select the communication mode.

The calculations and comparisons performed to select a communication mode may be modified in various ways. For example, when the first terminal 100 provides the channel information of the uplink to the second terminal 12, the second terminal 12 may perform the calculations and comparisons described above and provide the result of the comparison to the first terminal 100. As another example, when the second terminal 12 provides the channel information of the downlink and the channel information of the direct link to the first terminal 100, the first terminal 100 may perform the calculations and comparisons.

According to the example embodiment described above, the first terminal 100 may select the communication mode by taking into account the channel information of the uplink, the channel information of the downlink, and the channel information of the direct link. When channel quality of the direct link is determined to be better than channel quality of a link relayed through the base station 11 based on the calculations and comparisons using the channel information of the uplink, the channel information of the downlink, and the channel information of the direct link, the first terminal 100 may select the direct link for D2D communication. On the contrary, when channel quality of the link relayed through the base station 11 is determined to be better than the channel quality of the direct link, the first terminal 100 may select the link relayed through the base station 11 for cellular communication.

According to the example embodiment described above, compared to a previous base station-based method of selecting a communication mode, signaling needed for the first terminal 100 and the second terminal 12 to transmit the channel information of various links to the base station 11 may be reduced, and thus a total amount of signaling related to the communication mode selection may be reduced. Accordingly, signaling overheads for selecting a communication mode may be reduced or prevented from increasing.

Although it is not illustrated in FIG. 1, the second terminal 12 may attempt to transmit data to the first terminal 100 according to the D2D communication method. Here, the second terminal 12 may select a communication mode with the first terminal 100 via the same or substantially the same process as the first terminal 100.

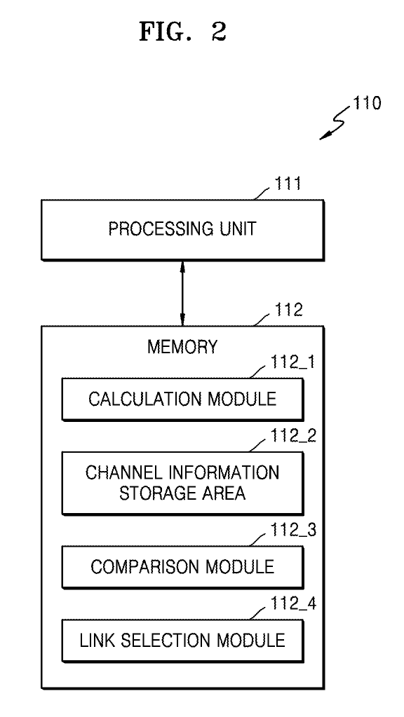

FIG. 2 is a block diagram of the mode selection circuit of FIG. 1, according to an example embodiment.

Various functions of a mode selection circuit 110 may be performed in a hardware manner, or in a software manner by executing programs. In some example embodiments, various functions of the mode selection circuit 110 may be performed in a combination of a hardware manner and a software manner. FIG. 2 illustrates an example of the mode selection circuit 110 in which various functions of the mode selection circuit 110 are performed in the software manner.

Referring to FIGS. 1 and 2, the mode selection circuit 110 may include a processing unit 111 for executing programs, and a memory 112 for storing programs, which realize various functions of the mode selection circuit 110. The memory 112 is a computer-readable storage medium, and may be realized as various types of storage media, for example, random access memory (RAM), flash memory, read only memory (ROM), electrically erasable programmable read only memory (EEPROM), or a magnetic disc storage device.

The programs stored in the memory 112 may be divided into various types of modules, according to functions of the programs. For example, the programs stored in the memory 112 may include a calculation module 112_1, a comparison module 112_3, and a link selection module 112_4. Further, the memory 112 may include a channel information storage area 112_2 for storing various channel information for selecting a communication mode.

The processing unit 111 may execute various programs stored in the memory 112 to perform terminal-based communication mode selection. The processing unit 111 may include a central processing unit (CPU), a control circuit, or the like. For example, the processing unit 111 may perform various calculation operations by executing the programs of the calculation module 112_1. That is, the calculation operations using at least one of various types of channel information described above, namely, the channel information of the uplink, the channel information of the downlink, and the channel information of the direct link, may be performed and results of the calculation operations may be generated.

Also, the processing unit 111 may perform comparison operations by executing the programs of the comparison module 112_3. That is, the comparison operations using the channel information of the uplink, the channel information of the downlink, and the channel information of the direct link described above may be performed, or the comparison operations using the results of the calculation operations and at least one of the channel information of the uplink, the channel information of the downlink, and the channel information of the direct link may be performed. In some example embodiments, a certain threshold value may be set, and the comparison operations using the threshold value may be performed.

The processing unit 111 may select a link to perform communication by executing the programs of the link selection module 112_4. For example, whether the link relayed through the base station 11 has a better quality (or a poor quality) than the direct link may be determined based on results of the comparison operations. Accordingly, based on the results of the comparison operations, the link relayed through the base station 11 or the direct link for D2D communication may be selected.

For example, when the first terminal 100 corresponds to a transmitting terminal in the D2D communication, the described calculation operations may be performed by the second terminal 12 corresponding to a receiving terminal, and the results of the calculation operations may be included in a channel response message and provided to the first terminal 100. The first terminal 100 may select a communication mode based on a comparison operation with respect to the previously obtained channel information of the uplink and the received results of the calculation operations. According to some example embodiments, the calculations and comparisons for selecting a communication mode may be appropriately distributed between the first terminal 100 and the second terminal 12.

According to a modified example embodiment, when the mode selection circuit 110 is realized in a hardware manner, the mode selection circuit 110 may include various logic circuits for performing the calculations, the comparisons, and the selections, and a storage area for storing the obtained channel information or the results of the calculations.

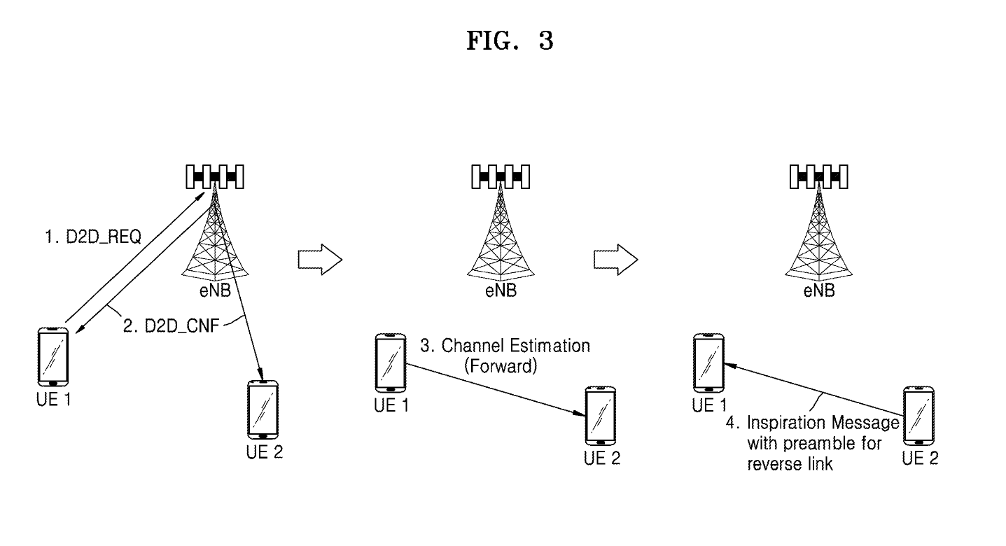

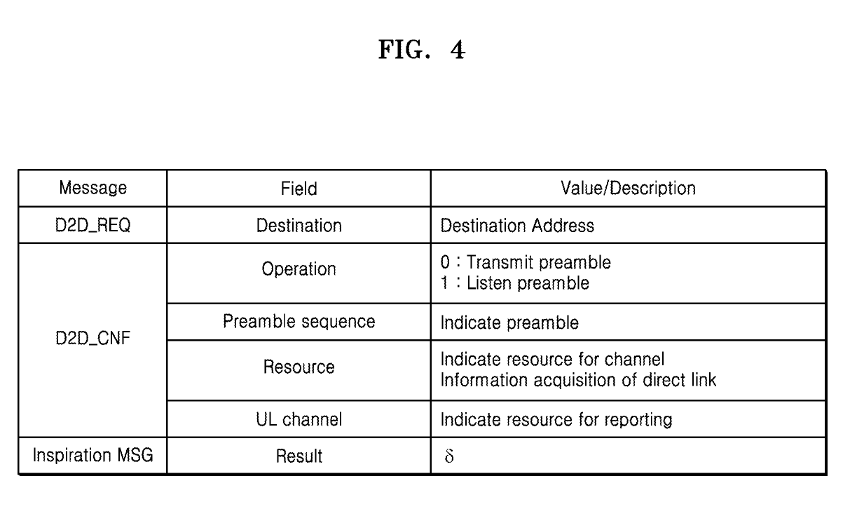

FIGS. 3 and 4 are views of signaling and a structure of a message for selecting a communication mode, according to some example embodiment. In the example embodiment of FIGS. 3 and 4, it is assumed that a first terminal UE 1 corresponds to a transmitting terminal, and a second terminal UE 2 corresponds to a receiving terminal.

First, the first terminal UE 1 maintains a link with the base station eNB, and while maintaining the link, may periodically or non-periodically transmit the channel information of the downlink to the base station eNB and/or receive the channel information of the uplink from the base station eNB. That is, in the process of selecting the communication mode for establishing the D2D communication, the channel information of the uplink to the base station eNB, and the channel information of the downlink from the base station eNB may be obtained without additional signaling.

Referring to FIG. 3, the first terminal UE 1 may transmit a D2D request message D2D_REQ to the base station eNB in order to attempt the D2D communication with the second terminal UE 2. The D2D request message D2D_REQ may include an address of the second terminal UE 2 corresponding to the receiving terminal.

The base station eNB may transmit a D2D response message D2D_CNF to the first terminal UE 1 and the second terminal UE 2 in response to the D2D request message D2D_REQ from the first terminal UE 1 so that the channel information of the direct link for the D2D communication may be calculated (or estimated). The D2D response message D2D_CNF from the base station eNB may include a preamble for calculating the channel information of the direct link, together with resources of the direct link.

The first terminal UE 1 and the second terminal UE 2 may perform signaling for calculating the channel information of the direct link by using the D2D response message D2D_CNF provided from the base station eNB. For example, the first terminal UE 1 may transmit a channel information calculation message including the preamble to the second terminal UE 2, thereby requesting the second terminal UE 2 to calculate the channel information (e.g., forward channel information) of the direct link. The second terminal UE 2 may generate a calculation result δ by using the calculated channel information of the direct link and the pre-obtained channel information of the downlink from the base station eNB and transmit a channel response message (e.g., Inspiration Message MSG) including the calculation result δ to the first terminal UE 1. Next, the first terminal UE 1 may select a communication mode based on the calculation result δ provided from the second terminal UE 2. For example, the first terminal UE 1 may select the communication mode based on a comparison operation using the channel information of the uplink to the base station eNB and the calculation result δ from the second terminal UE 2.

According to an example embodiment, the operation of selecting the communication mode may be performed by further calculating reverse channel information of the direct link. For example, the channel response message (e.g., Inspiration MSG) transmitted by the second terminal UE 2 may further include a preamble for calculating the reverse channel information of the direct link. According to some example embodiments, the second terminal UE 2 may further transmit, to the first terminal UE 1, a channel information calculation message including the preamble for calculating the reverse channel information, together with the channel response message (e.g., Inspiration MSG). For example, the preamble used to calculate the reverse channel information may have the same value as the preamble provided from the base station eNB.

The first terminal UE 1 may directly calculate the reverse channel information of the direct link by using the preamble provided from the second terminal UE 2. The first terminal UE 1 may determine whether an acknowledgement signal Ack in response to data transmission may be appropriately received via the reverse channel, according to a result of calculating the reverse channel information. That is, the first terminal UE 1 may further determine the usefulness of the reverse channel, and when the direct link is determined to be suitable for bi-directional communication, may select the D2D communication mode.

FIG. 4 is a table showing structures of various messages described above. Referring to FIG. 4, the D2D request message D2D_REQ transmitted by the first terminal UE 1 to the base station eNB may include a destination field, which has address information of the second terminal UE 2 corresponding to the receiving terminal.

The D2D response message D2D_CNF transmitted by the base station eNB to the first terminal UE 1 and the second terminal UE 2 may include an operation field indicating whether each of the first terminal UE1 and the second terminal UE 2 is to perform an operation of transmitting the preamble or an operation of receiving the preamble. The first terminal UE 1 may transmit the preamble to the second terminal UE 2 according to information of the operation field having a first value (e.g., “0”). The second terminal UE 2 may receive the preamble from the first terminal UE 1 according to information of the operation field having a second value (e.g., “1”).

Further, the D2D response message D2D_CNF from the base station eNB may include a preamble sequence field having preamble information for calculating the channel information of the direct link, and may further include a resource field indicating the resource of the direct link used in the D2D communication. The D2D response message D2D_CNF from the base station eNB may further include an uplink channel field UL channel indicating a channel of the uplink for transmitting a result of calculating channel quality of the direct link to the base station eNB. Also, the second terminal UE 2 may transmit the channel response message (e.g., Inspiration MSG) to the first terminal UE 1, in response to the channel information calculation message provided from the first terminal UE 1, and the channel response message (e.g., Inspiration MSG) may include a calculation result field Result indicating the calculation result δ generated in the second terminal UE 2.

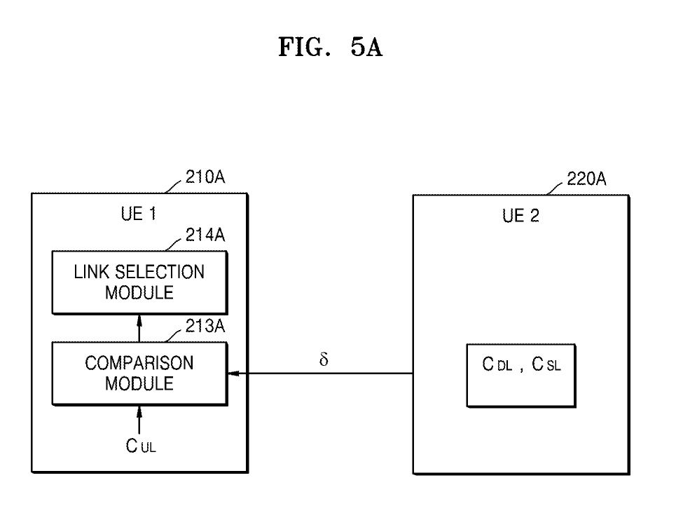

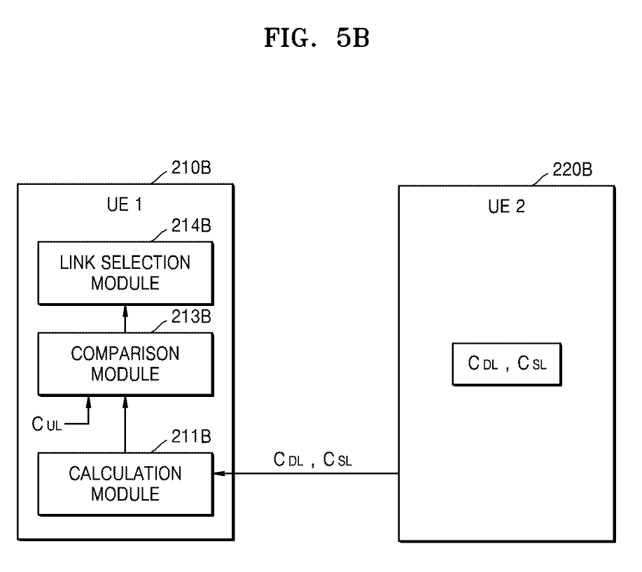

FIGS. 5A and 5B are block diagrams illustrating processes of selecting a communication mode in first and second terminals UE 1, 210A, and UE 2, 220A, according to some example embodiments.

Referring to FIG. 5A, the first terminal UE 1, 210A corresponds to a transmitting terminal, and the second terminal UE 2, 220A corresponds to a receiving terminal. Further, although not shown with regard to the second terminal UE 2, 220A, each of the first terminal UE, 210A and the second terminal UE 2, 220A may include the mode selection circuit 110 according to an example embodiment. As components of the mode selection circuit 110, a comparison module 213A and a link selection module 214A are illustrated in FIG. 5A.

As the first terminal 210A maintains a link with the base station, the first terminal 210A may store channel information C_{UL} of an uplink to a base station. Also, as the second terminal 220A maintains a link with the base station, the second terminal 220A may store channel information C_{DL} of a downlink from the base station, and may calculate and store channel information C_{SL} of a direct link.

According to an example embodiment, the second terminal 220A may generate a calculation result δ using the channel information C_{DL} of the downlink and the channel information C_{SL} of the direct link, and the first terminal 210A may receive the calculation result δ from the second terminal 220A. The comparison module 213A of the first terminal 210A may perform a comparison operation using the channel information C_{UL} of the uplink stored in the comparison module 213A and calculation result δ provided from the second terminal 220A, and provide a result of the comparison operation to the link selection module 214A. The link selection module 214A may select a communication mode based on the result of the comparison operation. For example, a link relayed through the base station or a direct link between the terminals may be selected based on the result of the comparison operation.

Referring to FIG. 5B, components of the mode selection circuit 110 may include a calculation module 211B, a comparison module 213B, and a link selection module 214B. Although not shown with regard to the second terminal UE 2, 220B, each of the first terminal 210B and the second terminal 220B may include the mode selection circuit 110 according to an example embodiment.

Functions of calculations and comparisons for selecting a mode may be assigned to the transmitting and receiving terminals in various ways. According to an example embodiment, the second terminal 220B may directly transmit the channel information C_{DL} of the downlink and the channel information C_{SL} of the direct link to the first terminal 210B. The calculation module 211B of the first terminal 210B may perform a calculation operation using the channel information C_{DL} and C_{SL} provided from the second terminal 220B and provide a result of the calculation operation to the comparison module 213B. The comparison module 213B may perform a comparison operation using the channel information C_{UL} of the uplink and the result of the calculation operation from the calculation module 211B, and the link selection module 214B may select a communication mode based on a result of the comparison operation.

In the example embodiments illustrated in FIGS. 5A and 5B, for convenience of explanation, all the modules included in the mode selection circuit 110 are described to perform corresponding functions in a hardware manner. However, example embodiments are not limited thereto. For example, as described above, the modules of the mode selection circuit 110 may be realized in a software manner, and the functions of the modules may be performed according to execution of programs by a processor.

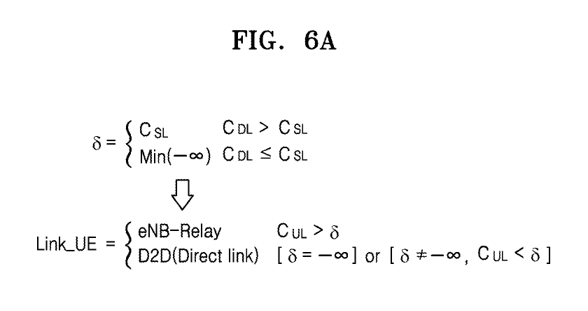

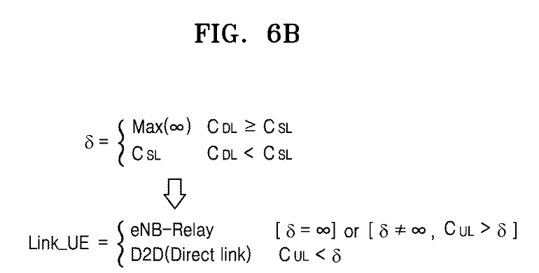

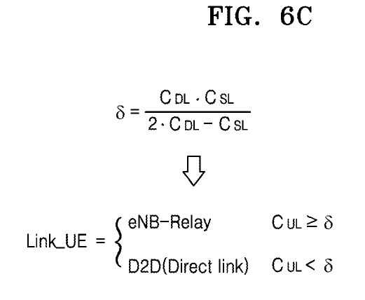

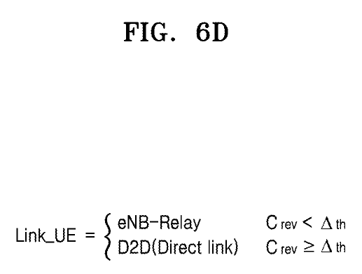

FIGS. 6A, 6B, 6C, and 6D are formulas representing examples of various calculations and comparisons related to selecting a communication mode. FIGS. 6A, 6B, 6C, and 6D show examples in which channel information indicating a value of channel quality corresponds to a channel capacity. Further, in the description hereinafter, a case in which a receiving terminal performs calculation using the channel information C_{DL} of the downlink and the channel information C_{SL} of the direct link and provides a calculation result δ to a transmitting terminal is described.

The calculations and comparisons for selecting a communication mode may be performed in various ways. For example, when channel quality of the direct link is better than at least one of channel quality of the downlink or channel quality of the uplink, it may be determined that D2D communication is better than cellular communication. In some example embodiments, the mode selecting operation may be set such that the D2D communication is selected when the channel quality of the direct link is better than both of the channel quality of the downlink and the channel quality of the uplink.

FIG. 6A illustrates an example in which a smaller value of a channel capacity of the downlink and a channel capacity of the uplink is compared with a channel capacity of the direct link. Referring to FIG. 6A, the receiving terminal performs calculation using channel information C_{DL} of the downlink and channel information C_{SL} of the direct link and transmits a result δ of the calculation to the transmitting terminal. The receiving terminal may generate the calculation result δ based on the magnitude of the channel information C_{DL} of the downlink and the channel information C_{SL} of the direct link.

For example, when the channel capacity of the downlink is equal to or less than the channel capacity of the direct link, the channel quality of the direct link may be indicated to be better than the channel quality of the downlink, and in this case, a certain minimum value (or a value of minus infinity) may be transmitted to the transmitting terminal as the calculation result δ. The minimum value Min may have a sufficiently small value to be always smaller than the channel information C_{UL} of the uplink in a sequential comparison operation. On the contrary, when the channel capacity of the downlink exceeds the channel capacity of the direct link, the channel quality of the downlink may be indicated to be better than the channel quality of the direct link, and in this case, a value corresponding to the channel information C_{SL} of the direct link may be transmitted to the transmitting terminal as the calculation result δ.

The transmitting terminal may perform a comparison operation by using the calculation result δ provided from the receiving terminal and may select a communication mode based on a result of the comparison. For example, the transmitting terminal may compare the calculation result δ with the magnitude of the channel information C_{UL} of the uplink.

For example, when the calculation result δ corresponds to the minimum value Min, the transmitting terminal may select the direct link. Also, even though the calculation result δ does not correspond to the minimum value Min, the direct link may be selected when the calculation result δ (or the channel information C_{SL} of the direct link) is greater than the channel information C_{UL} of the uplink. On the contrary, when the calculation result δ does not correspond to the minimum value Min and the channel information C_{UL} of the uplink is greater than the calculation result δ, a link relayed through the base station for cellular communication may be selected.

FIG. 6B illustrates an example in which a greater value of the channel capacities of the downlink and the uplink is compared with the channel capacity of the direct link.

Referring to FIG. 6B, when the channel capacity of the downlink is equal to or greater than the channel capacity of the direct link, the channel quality of the downlink may be indicated to be better than the channel quality of the direct link, and in this case, a certain maximum value (or a value of infinity) may be transmitted to the transmitting terminal as the calculation result δ. The maximum value Max may be a sufficiently great value to be always greater than the channel information C_{UL} of the uplink in a sequential comparison operation. On the contrary, when the channel capacity of the downlink is less than the channel capacity of the direct link, the channel quality of the direct link may be indicated to be better than the channel quality of the downlink, and in this case, a value corresponding to the channel information C_{SL} of the direct link may be transmitted to the transmitting terminal as the calculation result δ.

The transmitting terminal may perform a comparison operation by using the calculation result δ provided from the receiving terminal and may select a communication mode based on a result of the comparison. For example, the transmitting terminal may compare the calculation result δ with the magnitude of the channel information C_{UL} of the uplink.

For example, when the calculation result δ corresponds to the maximum value Max, the transmitting terminal may select a link relayed through the base station. Also, even though the calculation result δ does not correspond to the maximum value Max, the link relayed through the base station may be selected when the channel information C_{UL} of the uplink is greater than the calculation result δ.

On the contrary, according to a result of comparing the channel information C_{UL} of the uplink with the calculation result δ, when the calculation result δ is greater than the channel information C_{UL} of the uplink, the direct link for D2D communication may be selected.

FIG. 6C illustrates an example in which a communication mode is selected by using a harmonic mean of the channel information C_{UL} of the uplink and the channel information C_{DL} of the downlink. That is, a communication mode may be selected by calculating a mean value in a certain time period (e.g., a long term) and performing a comparison operation based on the calculated mean value rather than comparing values of the channel information in real time. According to this example embodiment, accuracy in selecting a communication mode based on channel quality may be improved.

Referring to FIG. 6C, the receiving terminal performs calculation using the channel information C_{DL} of the downlink and the channel information C_{SL} of the direct link and transmits a calculation result δ to the transmitting terminal. The transmitting terminal may perform various comparison operations using the calculation result δ provided from the receiving terminal and the channel information C_{UL} of the uplink stored in the transmitting terminal. For example, as shown in the formula illustrated in FIG. 6C, a result of performing comparison with respect to the calculation result δ and the channel information C_{UL} of the uplink may correspond to a result of comparing the harmonic mean of the channel information C_{UL} of the uplink and the channel information C_{DL} of the downlink with the channel information C_{SL} of the direct link. According to a result of the comparison, when the channel information C_{UL} of the uplink is equal to or greater than the calculation result δ, the link relayed through the base station may be selected, whereas when the channel information C_{UL} of the uplink is smaller than the calculation result δ, the direct link may be selected.

In the example embodiment of FIG. 6C, when the channel quality of the direct link is better than the channel qualities of the uplink and the downlink, the D2D communication mode may be selected, like the example embodiments described above.

FIG. 6D illustrates an example of a comparison operation using reverse channel information, when the reverse channel information is further used in selecting a communication mode. For example, even though a forward channel quality of the direct link is better than the channel quality of the link relayed through the base station, the cellular communication mode may be selected when the reverse channel quality of the direct link is equal to or less than a certain threshold value.

Referring to FIG. 6D, reverse channel information Cᵣₑᵥ may be calculated by the transmitting terminal as in the example embodiments described above. Also, the transmitting terminal may store a certain threshold value Δth to compare with the reverse channel information Cᵣₑᵥ. The transmitting terminal may compare the calculated reverse channel information Cᵣₑᵥ with the threshold value Δth and select the communication mode based on a result of the comparison. For example, when the reverse channel information Cᵣₑᵥ is equal to or less than the threshold value Δth, the cellular communication mode may be selected, and when the reverse channel information Cᵣₑᵥ is greater than the threshold value Δth, the D2D communication mode may be selected.

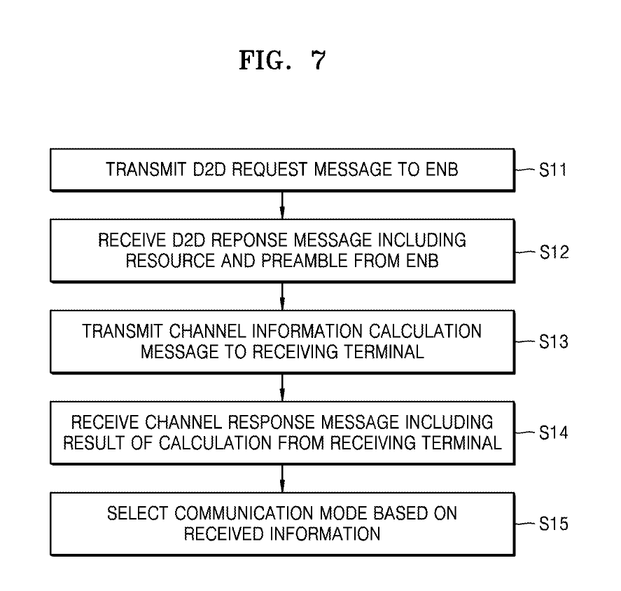

FIG. 7 is a flowchart illustrating an operation method of a communication terminal, according to an example embodiment. FIG. 7 illustrates an example operation of a transmitting terminal transmitting data to a receiving terminal.

Referring to FIG. 7, the transmitting terminal may transmit a D2D request message for establishing D2D communication to the base station eNB in order to transmit data to the receiving terminal, in operation S11. Also, in response to the D2D request message, the transmitting terminal may receive a D2D response message including a resource of a direct link and a preamble from the base station eNB in operation S12. The D2D response message from the base station eNB may be transmitted to the receiving terminal.

The receiving terminal may maintain a link with the base station eNB, and thus, may obtain channel information of a downlink from the base station eNB. Also, the transmitting terminal may transmit a channel information calculation message including the preamble included in the D2D response message to the receiving terminal via the resource of the direct link in operation S13. The receiving terminal may calculate channel information of the direct link in response to the channel information calculation message, and generate a calculation result using the calculated channel information and the pre-obtained channel information of the downlink. Also, the transmitting terminal may receive a channel response message including the calculation result from the receiving terminal in operation S14.

The transmitting terminal may maintain a link with the base station eNB, and thus, may obtain channel information of an uplink to the base station eNB. The transmitting terminal may select a communication mode based on information received from the receiving terminal in operation S15. For example, the transmitting terminal may select the communication mode based on a result of performing calculation and/or comparison using the calculation result provided from the receiving terminal and the pre-obtained channel information of the uplink.

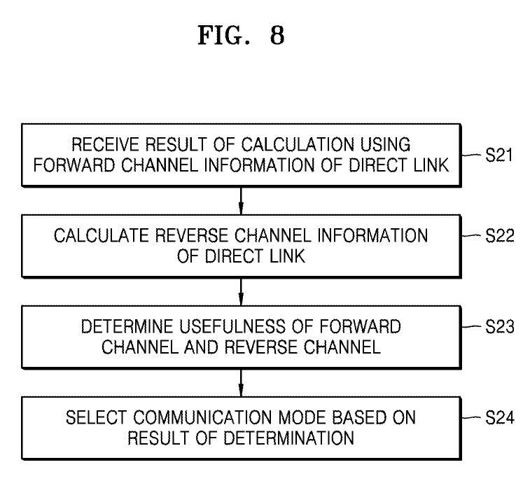

FIG. 8 illustrates an example of an operation of selecting a communication mode based on calculation of forward channel quality and reverse channel quality of the direct link, according to an example embodiment.

Referring to FIG. 8, the receiving terminal may perform calculation by using forward channel information and the pre-obtained channel information of the downlink, and the transmitting terminal may receive a calculation result using the forward channel information in operation S21. Also, the receiving terminal may transmit a preamble for calculating reverse channel information of the direct link to the transmitting terminal, and the transmitting terminal may calculate the reverse channel information of the direct link in operation S22.

Based on various information described above, the transmitting terminal may perform various calculations and comparisons to determine whether information may be appropriately transmitted via a forward channel and a reverse channel of the direct link. Via this, the transmitting terminal may determine the usefulness of the forward channel and the reverse channel in operation S23, and may select a communication mode according to a result of the determination of the usefulness in operation S24.

According to the example embodiment described above, the usefulness of not only the forward channel but also the reverse channel may be easily determined via less signaling, and via this, the communication mode may be selected, and thus stability of bi-directional communication of the direct link may be improved.

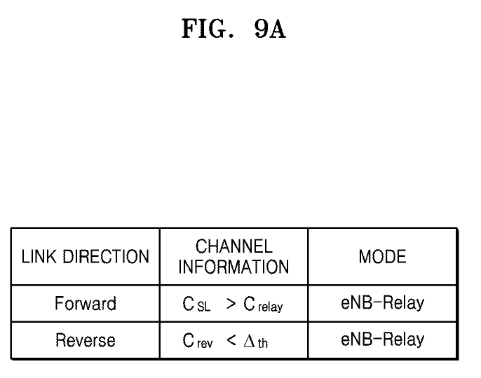

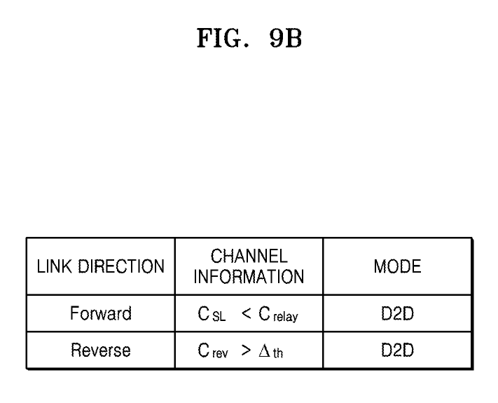

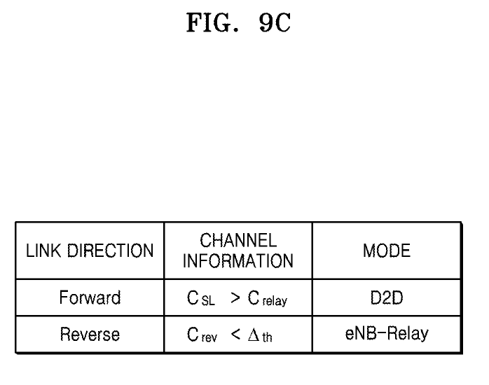

FIGS. 9A, 9B, and 9C are tables showing examples of selecting a communication mode according to qualities of the forward and reverse channels of the direct link. According to some example embodiments of the present inventive concepts, the forward channel information and the reverse channel information of the direct link between the terminals may be calculated to determine whether to select a D2D communication mode between the terminals, and based on a calculation result, the communication mode may be selected in various ways.

Referring to FIG. 9A, channel information C_{SL} of the forward channel of the direct link may be compared with channel information C_{relay} of cellular communication. For example, the channel information of each channel may correspond to a capacity of the channel.

The channel information C_{relay} of the cellular communication may have a value related to the described channel information C_{UL} of the uplink to the base station and the channel information C_{DL} of the downlink from the base station. For example, the channel information C_{relay} of the cellular communication may correspond to a lesser value from among the channel information C_{UL} of the uplink and the channel information C_{DL} of the downlink. Here, comparison may be performed as to whether the channel information C_{SL} of the forward channel is greater than at least one of the channel information C_{UL} of the uplink or the channel information C_{DL} of the downlink.

According to an example embodiment, the channel information C_{relay} of the cellular communication may correspond to a greater value from among the channel information C_{UL} of the uplink and the channel information C_{DL} of the downlink. Here, comparison may be performed as to whether the channel information C_{SL} of the forward channel is greater than both the channel information C_{UL} of the uplink and the channel information C_{DL} of the downlink.

Also, according to an example embodiment, the channel information C_{relay} of the cellular communication may correspond to a harmonic mean of the channel information C_{UL} of the uplink and the channel information C_{DL} of the downlink. By comparing the channel information C_{SL} of the forward channel of the direct link with the channel information C_{relay} of the cellular communication which may be defined in various ways as described above, the link having a better quality to transmit data to the receiving terminal from the transmitting terminal may be determined.

Further, based on a comparison operation using the reverse channel information Cᵣₑᵥ, a link having a better quality to transmit data (or an acknowledgement signal) from the receiving terminal to the transmitting terminal may be determined. FIGS. 9A, 9B, and 9C illustrate the examples in which the reverse channel information Cᵣₑᵥ is compared with a certain threshold value Δth. However, example embodiments of the present inventive concepts are not limited thereto. For example, the reverse channel information Crev may be compared with channel information of a cellular link transmitted from the receiving terminal to the transmitting terminal after passing through the base station.

FIG. 9A illustrates an example in which when at least one of the forward channel and the reverse channel of the direct link is less appropriate to perform communication than the channel of the cellular communication, the transmitting terminal and the receiving terminal perform communication via the link relayed through the base station. For example, even though the forward channel of the direct link is appropriate to transmit data, when the reverse channel of the direct link has a bad characteristic, bi-directional communication may be performed via the link relayed through the base station.

FIG. 9B illustrates an example in which when at least one of the forward channel and the reverse channel of the direct link is more appropriate to perform communication than the channel of the cellular communication, the transmitting terminal and the receiving terminal may perform communication via the direct link. That is, even though the forward channel of the direct link is not appropriate to transmit data, when the reverse channel of the direct link has a better characteristic than the channel of the cellular communication, bi-directional communication may be performed via the direct link.

FIG. 9C illustrates the example in which the terminals perform bi-directional communication while each using a different communication mode, according to the forward channel and the reverse channel information of the direct link. For example, when the forward channel of the direct link is more appropriate to transmit data than the cellular communication, the transmitting terminal may transmit data to the receiving terminal via the direct link. On the contrary, when the reverse channel of the direct link is less appropriate to transmit data than the cellular communication, the receiving terminal may transmit data (or an acknowledgement signal) to the transmitting terminal via the link relayed through the base station.

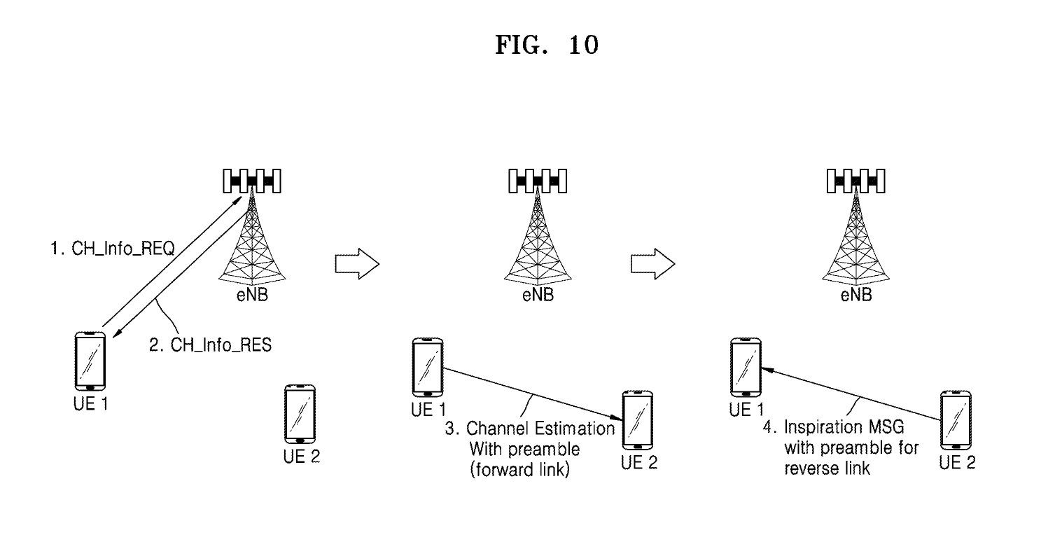

FIG. 10 is a view of an example of signaling for determining whether to maintain a selected link. FIG. 10 illustrates the example in which whether the direct link is to be maintained in a state in which a D2D communication mode is selected is determined.

Referring to FIG. 10, each of the first terminal UE 1 and the second terminal UE 2 maintains a link with the base station eNB, and the first terminal UE 1 may periodically transmit the channel information of the downlink from the base station eNB to the base station eNB, and transmit signaling for calculating the channel information of the uplink to the base station eNB to the base station eNB. Also, the second terminal UE 2 may obtain the channel information of the downlink from the base station eNB without additional signaling, according to the method described above.

It is assumed that the first terminal UE 1 corresponds to the transmitting terminal, and the first terminal UE 1 determines whether to maintain the link. First, the first terminal UE 1 transmits a channel information request message CH_Info_REQ to the base station eNB in order to obtain the channel information of the uplink to the base station eNB. The base station eNB transmits a channel information response message CH_Info_RES including the channel information of the uplink to the first terminal UE 1 in response to the channel information request message CH_Info_REQ. According to an example embodiment, the base station eNB may periodically transmit the channel information response message CH_Info_RES to the first terminal UE 1 without receiving the channel information request CH_Info_REQ from the first terminal UE 1.

The first terminal UE 1 transmits a preamble or data (e.g., channel estimation with preamble) to the second terminal UE 2 in order to calculate the channel information of the direct link. The second terminal UE 2 may calculate forward channel information of the direct link based on the received preamble or data, and may generate the calculation result δ and transmit the generated calculation result δ to the first terminal UE 1, according to some example embodiment described above. Also, the second terminal UE 2 may transmit a preamble (e.g., Inspiration MSG with preamble) for calculating reverse channel information of the direct link to the first terminal UE 1. The first terminal UE 1 may determine whether to maintain the link via a comparison operation using the calculation result δ related to the forward channel of the direct link and the channel information of the uplink. According to some example embodiment described above, when the reverse channel information of the direct link is further determined, whether to maintain the link may be determined by comparing the reverse channel information with a certain threshold value.

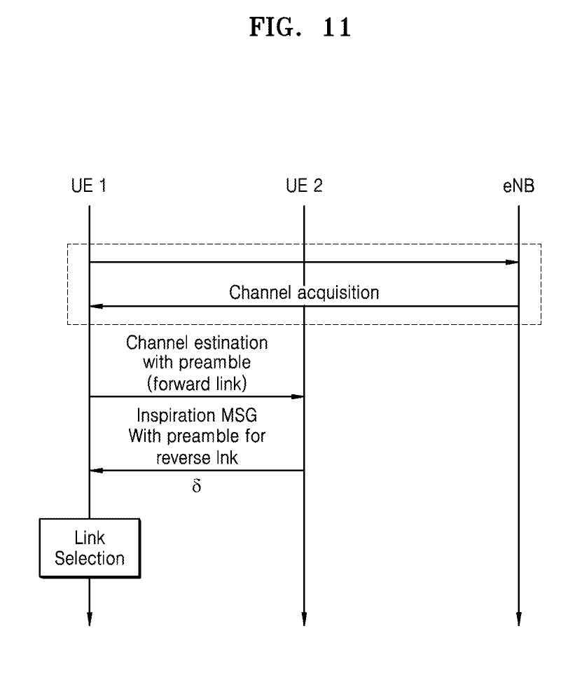

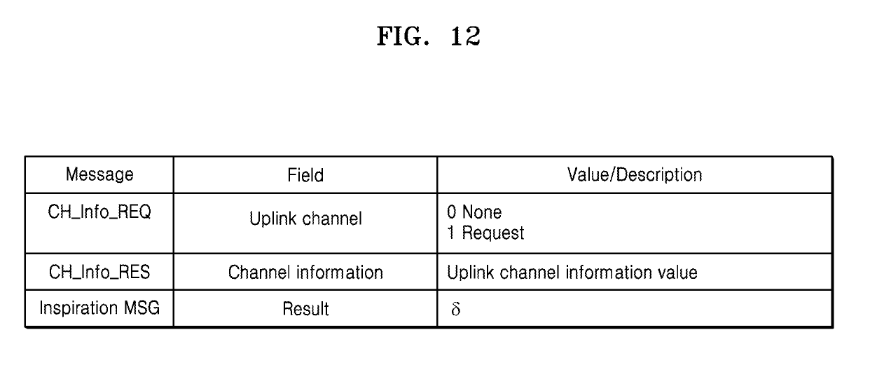

FIGS. 11 and 12 are views of a message and a structure of the message transmitted between the base station and the terminals for determining whether to maintain the link illustrated in FIG. 10.

Referring to FIG. 11, messages for obtaining channel information may be exchanged between the first terminal UE 1 and the base station eNB, and the messages exchanged between the first terminal UE 1 and the base station eNB may include the channel information request message CH_Info_REQ and the channel information response message CH_Info_RES illustrated in FIG. 10. Also, the first terminal UE 1 may transmit a message including a preamble for calculating the forward channel information of the direct link to the second terminal UE 2, and the second terminal UE 2 may transmit a message including the calculation result δ to the first terminal UE 1. Also, the message transmitted by the second terminal UE 2 may further include a preamble for calculating the reverse channel information of the direct link.

As illustrated in FIG. 11, signaling for determining whether to maintain a link may be reduced in amount, compared to a case in which a link for D2D communication is established. Referring to FIGS. 10 and 11, whether to maintain the link may be determined without performing the transmission of the channel information request CH_Info_REQ from the first terminal UE 1 to the second user terminal UE 2, and thus whether to maintain the link may be determined by using less signaling.

Referring to FIG. 12, the channel information request message CH_Info_REQ transmitted by the first terminal UE 1 to the base station eNB may include an uplink channel field indicating a channel of which information is to be obtained, and when the uplink channel field has a value in a certain state, the base station eNB may transmit the channel information response message CH_Info_RES to the first terminal UE 1. Also, the channel information response message CH_Info_RES may include a channel information field indicating the channel information of the uplink. Also, the message Inspiration MSG transmitted by the second terminal UE 2 may include a result field Result having the calculation result δ described above.

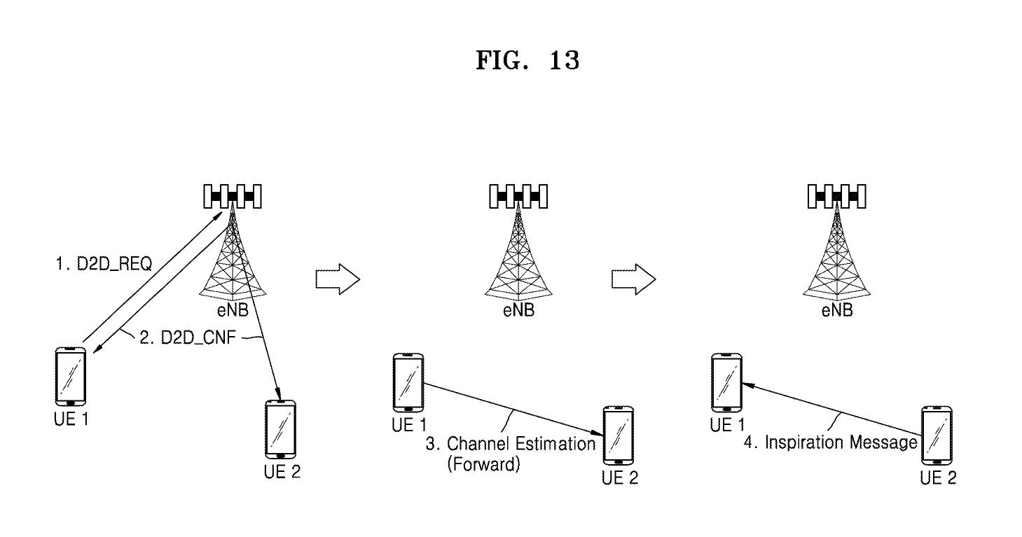

FIG. 13 is a view of an example of an operation of a communication system, the operation including selecting a communication mode by using only information of the forward channel of the D2D communication. Operations of components illustrated in FIG. 13, which are the same as or substantially similar to the example embodiments described above will not be described in detail.

Referring to FIG. 13, the first terminal UE 1 may transmit the D2D request message D2D_REQ for D2D communication with the second terminal UE 2 to the base station eNB. According to some example embodiments, the D2D request message D2D_REQ transmitted by the first terminal UE 1 may include an address of the second terminal UE 2 which is a target terminal of the D2D communication. Also, the base station eNB may transmit the D2D response message D2D_CNF including the resource of the direct link and the preamble for the D2D communication to the first terminal UE 1.

The first terminal UE 1 may transmit the channel information calculation message including the preamble to the second terminal UE 2 in order to calculate the forward channel information of the direct link, and the second terminal UE 2 may transmit, to the first terminal UE 1, the channel response message Inspiration MSG including the calculation result δ using the calculated forward channel information of the direct link and the channel information of the downlink from the base station eNB.

The first terminal UE 1 may select a communication mode based on the information included in the channel response message Inspiration MSG provided from the second terminal UE 2, and the channel information of the uplink to the base station eNB. For example, the communication mode may be selected with reference to only the quality of the forward channel of the direct link.

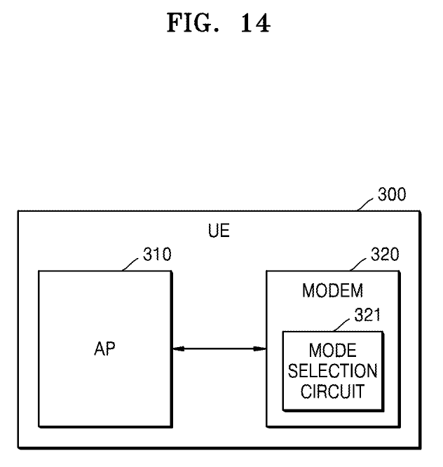

FIG. 14 is a block diagram of a modem chip 320 executing selecting of a communication mode, according to an example embodiment.

Referring to FIG. 14, the modem chip 320 may be mounted in a communication device 300, and may be controlled by an application processor 310 mounted in the communication device 300. The modem chip 320 may include a mode selection circuit 321, and the mode selection circuit 321 may select a communication mode as described above.

The mode selection circuit 321 may perform an operation of selecting a communication mode in a hardware or a software manner. As described above, when the communication mode is selected in the software manner, the mode selection circuit 321 may include a memory (not shown) for storing programs including various modules and a processing unit (not shown) for executing the programs stored in the memory. Further, the programs stored in the memory may include a calculation module performing calculation using channel information, a comparison module performing a comparison operation using a result of the calculation, and a link selection module selecting a link based on a result of the comparison.

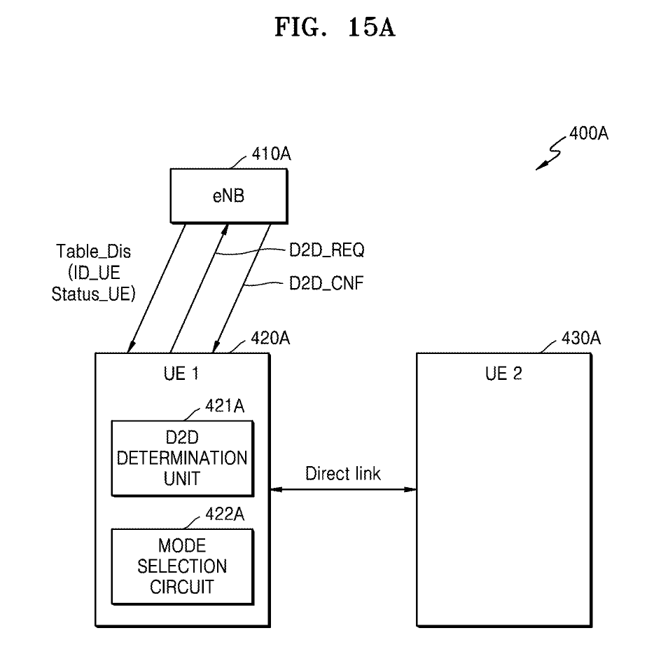

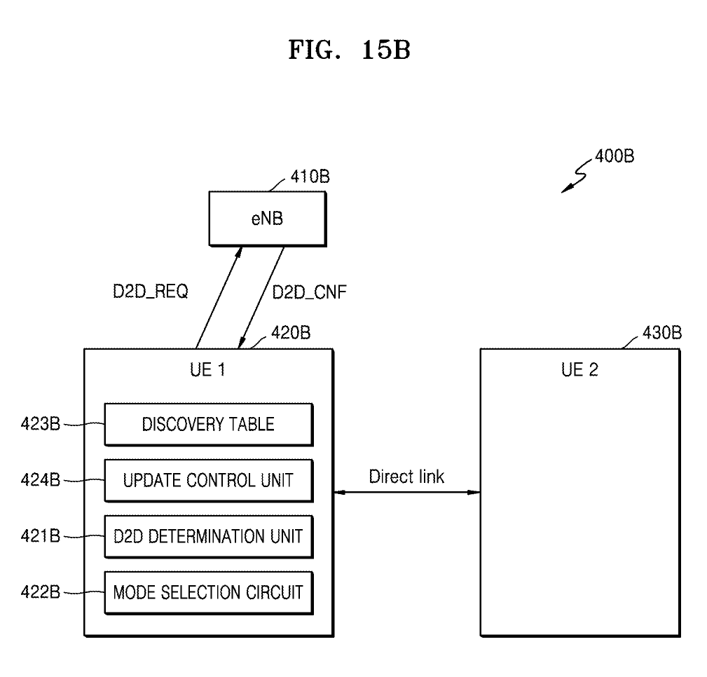

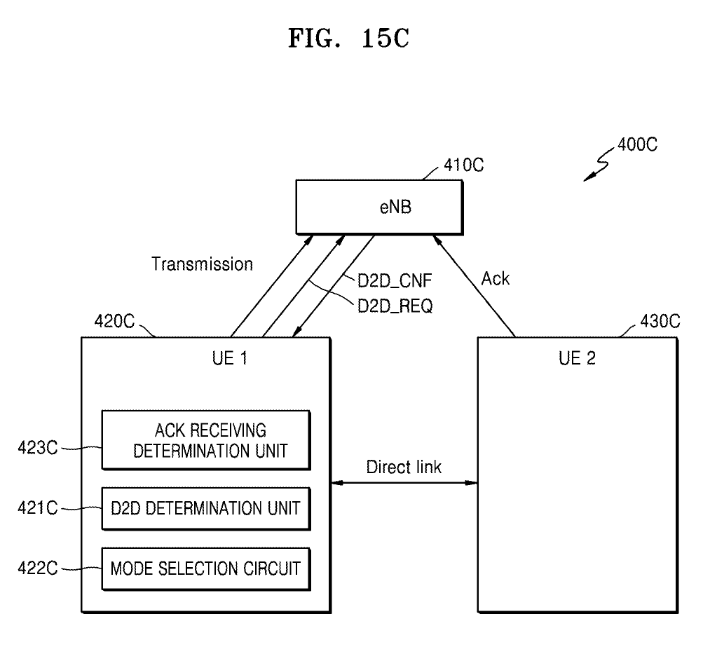

FIGS. 15A, 15B, and 15C are block diagrams of various examples of determining whether to attempt D2D communication. According to an example embodiment, before determining whether to select a D2D communication mode according to channel quality, whether a transmitting terminal is to attempt D2D communication with a receiving terminal may be determined under specific conditions.

Referring to FIG. 15A, a communication system 400A may include a base station eNB, 410A and two or more terminals, and the terminals may perform D2D communication in which communication is not relayed through the base station 410A. In the D2D communication, the first terminal UE 1, 420A transmitting data may correspond to a transmitting terminal, and the second terminal UE 2, 430A may correspond to a receiving terminal. The first terminal 420A may include a D2D determination unit 421A and a mode selection circuit 422A. Although it is not illustrated in FIG. 15A, the second terminal 430A may also perform a function for determining whether to attempt the D2D communication and a function for selecting a communication mode, like the first terminal 420A.

The D2D determination unit 421A is a block determining functions, and such functions of the D2D determination unit 421A may be realized in various ways. For example, when various determination and selection functions are realized in a software manner, the D2D determination unit 421A and the mode selection circuit 422A may be hardware HW, such as a CPU or a control circuit, or computer software SW performed in the CPU. For example, programs (or computer software) for realizing the functions of the D2D determination unit 421A may be stored in a memory (not shown) for storing programs in the mode selection circuit 422A.

The first terminal 420A may maintain a link according to cellular communication with the base station 410A. The first terminal 420A may periodically or non-periodically receive a discovery table Table_Dis from the base station 410A. The discovery table Table_Dis may include various types of information. For example, the discovery table Table_Dis may include address (or ID) information ID_UE of terminals located in a cell coverage covered by the base station 410A. Further, various types of information may be included in the discovery table Table_Dis. For example, state information (for example, distance information between terminals or a state of a channel connected to the terminals Status UE) of the terminals located in the cell coverage may be included.

The first terminal 420A may determine whether to attempt the D2D communication with the second terminal 430A, with reference to the information included in the discovery table Table_Dis provided from the base station 410A. According to an example embodiment, the D2D determination unit 421A may perform the determination operation with reference to the discovery table Table_Dis and provide a result of the determination operation to the mode selection circuit 422A. For example, the D2D determination unit 421A may provide the result of the determination, which indicates the attempt at the D2D communication, to the mode selection circuit 422A, when the number of terminals included in the discovery table Table_Dis (or the number of terminals located in the cell coverage) is greater than a certain threshold value. That is, when it is determined that a probability of error occurrence in the link relayed through the base station 410A increases as the number of terminals in the cell coverage of the base station 410A increases, the D2D communication may be attempted.

The mode selection circuit 422A may perform various functions for selecting a communication mode according to some example embodiments described above. For example, according to an operation of the mode selection circuit 422A, the first terminal 420A may transmit the D2D request message D2D_REQ for D2D communication to the base station 410A, and receive the D2D response message D2D_CNF including the resource of the direct link and the preamble for calculating the channel information of the direct link from the base station 410A. Also, according to the example embodiments described above, the first terminal 420A may select a communication mode based on results of various calculations and comparisons.

According to an example embodiment, each of the base station 410A and the first terminal 420A includes a plurality of transmitting and receiving antennas, and thus, may support a multiple input multiple output (MIMO) system. The discovery table Table_Dis may include information of terminals performing communication for each of the antennas of the base station 410A. That is, terminals located in a specific angle may perform communication via the same antenna of the base station 410A, and the first terminal 420A may determine information of other terminals located in a specific angle with respect to the first terminal 420A with reference to the discovery table Table_Dis. For example, when the second terminal 430A is located at a specific angle with respect to the first terminal 420A, the first terminal 420A may attempt D2D communication with the second terminal 430A.

Referring to FIG. 15B, a communication system 400B may include a base station 410B and two or more terminals 420B and 430B. Each of the terminals 420B and 430B may include various components related to D2D communication. For example, the first terminal 420B may include a D2D determination unit 421B, a mode selection circuit 422B, a discovery table 423B, and an update control unit 424B. The second terminal 430B may also include the same or substantially similar components as the first terminal 420B. According to an example embodiment, the D2D determination unit 421B, the mode selection circuit 422B, the discovery table 423B, and the update control unit 424B may be realized as computer software (SW) or data which is stored in hardware (HW) or memory, such as a CPU or a control circuit, and executed in the CPU.

The D2D determination unit 421B may determine whether to attempt D2D communication, and when it is determined to attempt the D2D communication, the mode selection unit 422B may select a communication mode based on results of calculations and comparisons using various channel information. When an operation of selecting the communication mode is performed, the D2D request message D2D_REQ and the D2D response message D2D_CNF may be transmitted and received between the first and second terminals 420B and 430B, according to the example embodiments described above.

Also, the discovery table 423B may store information related to terminals adjacent to the first terminal 420B (or located from the first terminal 420B within a distance of a certain threshold value). Also, the update control unit 424B may periodically or non-periodically perform a control operation for updating information of the discovery table 423B. For example, the first terminal 420B may periodically or non-periodically broadcast a certain signal and receive an acknowledgement signal Ack from a plurality of terminals which have received the signal, to update the discovery table 423B.

According to an example embodiment, the D2D determination unit 421B may determine whether the second terminal 430B which is to receive data via D2D communication corresponds to a terminal included in the discovery table 423B. That is, according to a result of the determination, whether the second terminal 430B is located sufficiently adjacent to the first terminal 420B so that the second terminal 430B may perform D2D communication with the first terminal 420B may be determined. According to a result of the determination, the mode selection circuit 422B may perform the operation of selecting a communication mode according to the example embodiments described above.

Referring to FIG. 15C, a communication system 400C may include a base station 410C and two or more terminals 420C and 430C. Each of the terminals 420C and 430C may include various components related to D2D communication. For example, the first terminal 420C may include a D2D determination unit 421C, a mode selection circuit 422C, and a response reception determination unit (e.g., ack receiving determination unit) 423C. The second terminal 430C may also include the same or substantially similar components as the first terminal 420C. According to an example embodiment, the D2D determination unit 421C, the mode selection circuit 422C, and the response reception determination unit 423C may be realized as SW stored in hardware HW or memory, such as a CPU or a control circuit, and executed in the CPU.

The first terminal 420C may perform cellular communication with the second terminal 430C relayed through the base station 410C, and the first terminal 420C may transmit data to the second terminal 430C and receive an acknowledgement signal Ack from the second terminal 430C. The response reception determination unit 423C may determine whether the acknowledgement signal Ack is appropriately received from the second terminal 430C in response to the data transmitted by the first terminal 420C to the second terminal 430C, and provide a result of the determination to the D2D determination unit 421C.

The D2D determination unit 421C may determine whether to attempt D2D communication, according to the result of the determination from the response reception determination unit 423C. For example, when the acknowledgement signal Ack is not appropriately received by N consecutive times even though the first terminal 420C transmits the data by N times, the D2D determination unit 421C may determine to attempt D2D communication. That is, when it is determined that a probability of error occurrence in cellular communication in which communication is relayed through the base station 410C increases since the acknowledgement signal Ack is not appropriately received by n consecutive times, the D2D communication may be attempted.

When it is determined to attempt the D2D communication, the mode selection circuit 422C may perform the operation of selecting a communication mode according to the example embodiments described above. According to an example embodiment, the D2D communication may be attempted when a certain number of acknowledgement signals Ack are not appropriately received, rather than when the acknowledgement signal Ack is not received by n consecutive times.

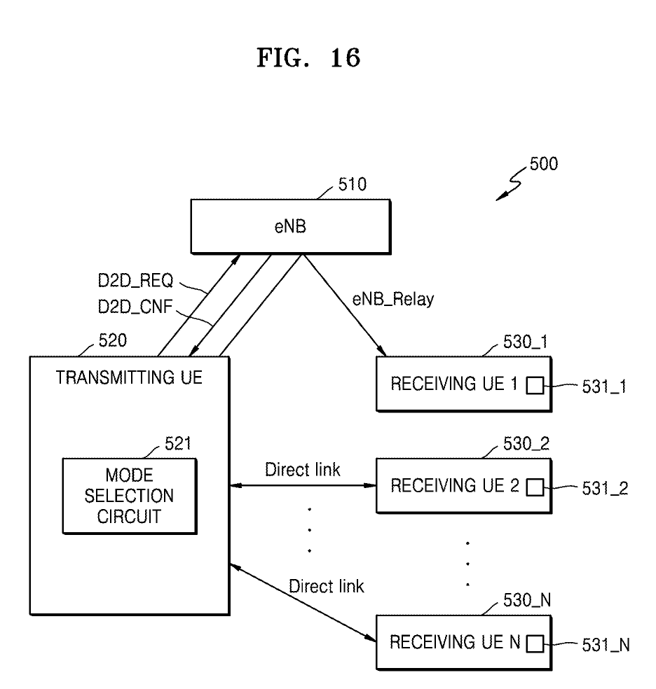

FIG. 16 is a block diagram of an example in which one transmitting terminal performs one-to-many D2D communication with at least two receiving terminals.

Referring to FIG. 16, a communication system 500 may include a base station eNB, 510, and a plurality of terminals, and from the perspective of D2D communication. The plurality of terminals may include one transmitting terminal 520 and a plurality of receiving terminals 530_1 through 530_N. The transmitting terminal 520 may include a mode selection circuit 521 for selecting a communication mode by using the channel information according to the described example embodiments. Also, the plurality of receiving terminals 530_1 through 530_N may include mode selection circuits 531_1 through 531_N for performing calculation related to communication mode selection.

The transmitting terminal 520 may transmit the D2D request message D2D_REQ to the base station 510, and the D2D request message D2D_REQ may include addresses of the receiving terminals 530_1 through 530_N. The D2D request message D2D_REQ may be transmitted in various ways. For example, an address of one of the plurality of receiving terminals 530_1 through 530_N may be included in each of D2D request messages D2D_REQ, and thus the plurality of D2D request messages D2D_REQ may be sequentially transmitted to the base station 510. In some example embodiments, addresses of the plurality of receiving terminals 530_1 through 530_N may be included in one D2D request message D2D_REQ.

According to the method of transmitting the D2D request message D2D_REQ, the selecting of the communication mode may be performed in various ways for each receiving terminal. For example, because the plurality of D2D request messages D2D_REQ each including the address of one receiving terminal are sequentially transmitted to the base station 510, the communication mode may be sequentially selected for the plurality of receiving terminals 530_1 through 530_N and the link may be selected.

According to some example embodiment, signaling may be performed such that after the D2D request message D2D_REQ including one address is transmitted to the base station 510 and a communication mode with a receiving terminal corresponding to the address of the D2D request message D2D_REQ is selected, the D2D request message D2D_REQ for another receiving terminal may be transmitted to the base station 510.

The transmitting terminal 520 may receive the D2D response message D2D_CNF from the base station 510 and select the communication mode for each of the plurality of receiving terminals 530_1 through 530_N by using information included in the D2D response message D2D_CNF. According to the results of various calculations and comparisons according to the described example embodiments, the link relayed through the base station 510 may be selected for some of the plurality of receiving terminals 530_1 through 530_N, and the direct link may be selected for the rest of the plurality of receiving terminals 530_1 through 530_N.

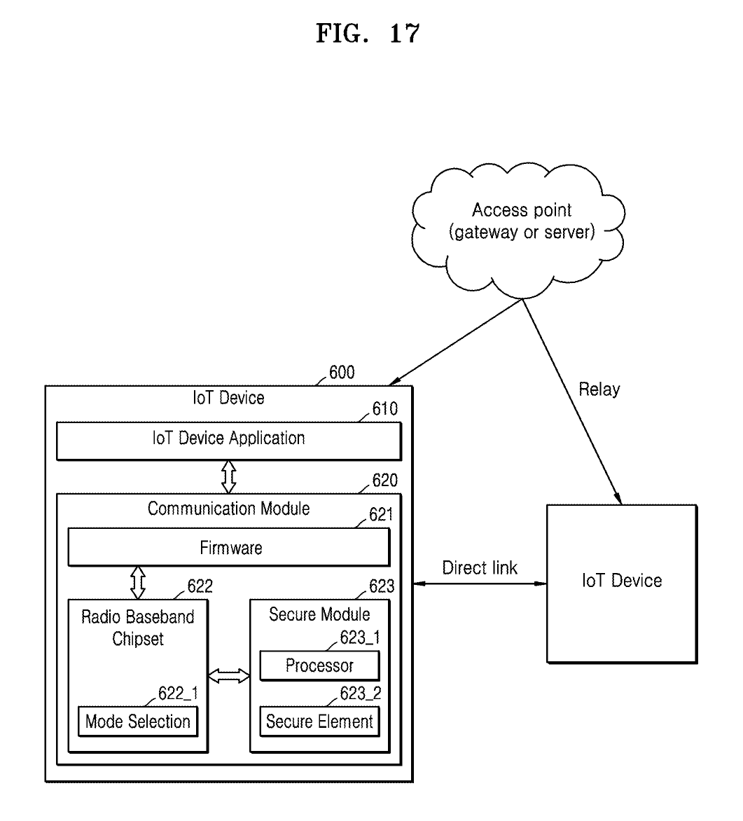

FIG. 17 is a block diagram of an example in which the communication method according to an example embodiment is applied to an internet of things.

The internet of things (IoT) may refer to a network between things using wired/wireless communication. The IoT device may include devices having an accessible wired or wireless interface and transmitting or receiving data by communicating with at least one another device via the wired/wireless interface. For example, the IoT device may correspond to various types of communicable devices, such as a refrigerator, an air conditioner, a telephone, an automobile, etc.

The example embodiments described above may be applied to the IoT. For example, the base station may be applied to AP, a gateway, a server, etc. in the IoT. Also, the terminals may correspond to the IoT device. Any one IoT device may perform communication with another IoT device via the AP, the gateway, or the like, or perform D2D communication according to the embodiments described above.

Referring to FIG. 17, an IoT device 600 may include an IoT device application 610 and a communication module 620. The communication module 620 may include firmware 621, a wireless (e.g., radio) baseband chip set 622, a security module 623, etc.

The IoT device application 610, which is a software component, may control the communication module 620 and may be executed by a CPU (not shown) in the IoT device 600. The communication module 620 may refer to a wireless communication component linked to or capable of exchanging data with local area network (LAN), wireless LAN (WLAN), such as Wi-fi, wireless universal serial bus (USB), Zigbee, or a mobile communication network.

The firmware 621 may provide an application programming interface (API) with the IoT device application 610 and control the wireless baseband chip set 622 according to control of the IoT device application 610. The wireless baseband chip set 622 may provide connectivity to a wireless communication network. The security module 623 may include a processor 623_1 and a security element 623_2. The security module 623 may authenticate the IoT device 600 for connection to the wireless communication network and authenticate the IoT device 600 for an access to a wireless network service.

According to some example embodiments, the IoT device 600 may determine whether to attempt D2D communication with another IoT device, and based on various channel information, may select whether to perform communication relayed through the AP, or the D2D communication between the IoT devices. According to the embodiments described above, the IoT device 600 may include a mode selection circuit 622_1 for selecting a communication mode.

FIG. 17 illustrates that the mode selection circuit 622_1 is provided in the wireless baseband chip set 622. However, example embodiments of the present inventive concepts are not limited thereto. For example, when the mode selection function is realized in a software manner, a memory for storing programs and a processor for executing the programs may be provided in the wireless baseband chip set 622. In some example embodiments, the memory for storing programs may be provided in the wireless base band chip set 622, while the processing unit for executing the programs may be executed by a CPU (not shown) of the IoT device 600. Furthermore, the memory for storing programs may be provided outside the wireless baseband chip set 622.

While the inventive concepts have been particularly shown and described with reference to some example embodiments thereof, it will be understood that various changes in form and details may be made therein without departing from the spirit and scope of the following claims.

What is claimed is:

1. An operating method of a communication device, the method comprising:
receiving a first message, the first message including resources of a direct link for device-to-device (D2D) communication from a base station;
receiving a second message, the second message including first information from a counterpart terminal of the D2D communication, the first information related to channel information of a downlink of cellular communication and channel information of the direct link; and
selecting one of the cellular communication or the D2D communication as a communication mode with the counterpart terminal, based on channel information of an uplink of the cellular communication and the received first information.

2. The operating method of claim 1, further comprising:
transmitting a D2D request message to the base station before receiving the first message, the D2D request message including an address of the counterpart terminal.

3. The operating method of claim 2, wherein the transmitting a D2D request message is selectively performed when a discovery table in the communication device includes information of the counterpart terminal.

4. The operating method of claim 1, wherein the first information includes calculation results of the channel information of the downlink and the channel information of the direct link.

5. The operating method of claim 1, wherein the first information includes both the channel information of the downlink and the channel information of the direct link.

6. The operating method of claim 1, wherein the selecting one of the cellular communication and the D2D communication as a communication mode includes selecting the D2D communication when a channel capacity of the direct link is greater than channel capacities of the downlink and the uplink, according to the channel information of the direct link, the downlink, and the uplink.

7. The operating method of claim 1, further comprising:
after the receiving a first message and before the receiving a second message, providing a channel information calculation message including a first preamble to the counterpart terminal to calculate forward channel information of the direct link as the channel information of the direct link.

8. The operating method of claim 7, wherein
the second message further includes a second preamble to calculate reverse channel information of the direct link, and
the selecting one of the cellular communication and the D2D communication as a communication mode includes selecting the communication mode based on both the forward channel information and the reverse channel information of the direct link.

9. The operating method of claim 8, wherein the selecting one of cellular communication and the D2D communication as a communication mode includes selecting the D2D communication when a forward channel capacity is greater than channel capacities of the downlink and the uplink, and a reverse channel capacity is greater than a threshold value, according to the forward channel information and the reverse channel information.

10. The operating method of claim 1, further comprising:
determining whether to maintain the direct link after the D2D communication mode is selected, the determining including,
receiving a third message from the base station, the third message including the channel information of the uplink,
receiving a fourth message from the counterpart terminal, the fourth message including a calculation result using the channel information of the downlink and the channel information of the direct link, and
determining whether to maintain the direct link based on the channel information of the uplink and the calculation result.

11. The operating method of claim 1, wherein the first message comprises:
a first field indicating that the communication device is to transmit a preamble to the counterpart terminal;
a second field having preamble information for calculating the channel information of the direct link;
a third field indicating the resources of the direct link; and
a fourth field indicating a channel of the uplink, through which the calculated channel information of the direct link is transmitted to the base station.

12. A communication device performing device-to-device (D2D) communication, the communication device comprising:
a memory configured to store programs related to selecting a communication mode; and
a processor connected to the memory and configured to execute the programs to,
perform a comparison operation using first information provided from an counterpart terminal of the D2D communication and second information stored in the communication device; and
select one of cellular communication and the D2D communication as a communication mode with the counterpart terminal based on a result of the comparison operation.

13. The communication device of claim 12, wherein
the first information includes a result of calculating channel information of a downlink of the cellular communication and forward channel information of a direct link for the D2D communication, and
the second information includes channel information of an uplink of the cellular communication.

14. The communication device of claim 13, wherein
the communication device is configured to receive a preamble for calculating reverse channel information of the direct link for the D2D communication from the counterpart terminal, and
the processor is configured to,
compare the calculated reverse channel information with a threshold value, and
select the communication mode based on a result of the comparison by executing the programs stored in the memory.

15. The communication device of claim 12, wherein the communication device is configured to,
transmit a D2D request message for the D2D communication to a base station,
receive a first message from the base station, the first message including resources of a direct link for the D2D communication,
transmit a channel information calculation message for calculating channel information of the direct link to the counterpart terminal, and
receive a second message from the counterpart terminal, the second message including the calculated channel information.

16. An operating method of a communication device, the method comprising:
preforming signaling at least one of periodically or non-periodically between at least one base station and a plurality of devices including the communication device;
receiving a first message, the first message including resources of a direct link for device-to-device (D2D) communication from the base station;
transmitting a channel information calculation message to at least one counterpart device from among the plurality of devices;
receiving a second message from the counterpart device, the second message including first information from the counterpart device of the D2D communication, the first information being a value calculated using channel information of a downlink of cellular communication and channel information of the direct link; and
selecting one of the cellular communication or the D2D communication as a communication mode with the counterpart device, based on channel information of an uplink of the cellular communication and the received first information.

17. The operating method of claim 16, further comprising:
after the receiving a first message and before the receiving a second message, providing a channel information calculation message including a first preamble to the counterpart device to calculate forward channel information of the direct link as the channel information of the direct link.

18. The operating method of claim 17, wherein the second message further includes a second preamble to calculate reverse channel information of the direct link, and
the selecting one of the cellular communication and the D2D communication as a communication mode includes selecting the communication mode based on both the forward channel information and the reverse channel information of the direct link.

19. The operating method of claim 18, wherein the selecting one of cellular communication and the D2D communication as a communication mode includes
selecting the D2D communication when a forward channel capacity included in the forward channel information is greater than channel capacities of the downlink and the uplink, and a reverse channel capacity included in the reverse channel information is greater than a threshold value.

20. The operating method of claim 16, wherein the first message comprises:
a first field indicating that the communication device is to transmit a preamble to the counterpart device;
a second field having preamble information for calculating the channel information of the direct link;
a third field indicating the resources of the direct link; and
a fourth field indicating a channel of the uplink, through which the calculated channel information of the direct link is transmitted to the base station.
